(19) United States
(12) Patent Application Publication
(10) Pub. No.: US 2007/0017159 A1
(43) Pub. Date: Jan. 25, 2007

(54) Attachment of guide rail to door module plate

(75) Inventor: Ronald Moore, Sterling Heights, MI (US)

Correspondence Address: YOUNG & BASILE, P.C., 3001 WEST BIG BEAVER ROAD, SUITE 624, TROY, MI, 48084, US

(73) Assignee: Hi-Lex Corporation, a Michigan corporation, Troy, MI (US)

(21) Appl. No.: 11/185,598

(22) Filed: Jul. 20, 2005

(51) Int. Cl. E05F 11/48

(52) U.S. Cl. 49/502; 49/352

(57) ABSTRACT

A motor vehicle door module including a module plate, a vertical rail secured to the module plate, and a glass carrier mounted for vertical sliding movement on the rail. The module plate includes a main body planar plate portion and a pair of vertically spaced annular pedestals upstanding from the main body planar plate portion. Each pedestal defines a smooth cylindrical bore and an annular concave conical seat formed at the free end of the pedestal in surrounding relation to the bore. The rail includes a pair of vertically spaced apertures with a concave conical seat in surrounding relation to each aperture sized to nest in the respective pedestal conical seat. The assembly further includes a pair of self-tapping screws each having a conical flat head sized to seat in a respective rail seat. In assembled relation each conical head of each screw nests in a conical rail seat, each rail seat nests in a pedestal seat, and a threaded shank of each screw self-tappingly engages the smooth cylindrical bore of the respective pedestal.

### BACKGROUND

This invention relates to motor vehicle door assemblies and more particularly to a door module for use in forming a motor vehicle door assembly.

In the assembly of a present day motor vehicle door the inner door panel is typically provided with an opening and a module plate, typically from a supplier, is fastened in the opening by the OEM. The module plate carries various door accessory items including a guide rail slidably supporting a glass carrier to raise and lower the window glass. While this overall construction is generally satisfactory, the process whereby the rail is attached to the module plate is relatively expensive both from a parts standpoint and a labor standpoint.

### SUMMARY OF THE INVENTION

This invention is directed to the provision of and improved door module.

More particularly this invention is directed to the provision of a door module incorporating an improved arrangement for securing the guide rail to the module plate.

The invention concerns a door module of the type including a module plate and a glass carrier guide rail secured to the module plate. According to the invention the module plate includes a main body planar plate portion and a pair of vertically spaced annular pedestals upstanding from the main body planar plate portion; each pedestal defines a cylindrical bore and an annular concave conical seat in surrounding relation to the bore at the free end of the pedestal; the rail includes a pair of vertically spaced apertures with a concave conical seat in surrounding relation to each aperture sized to nest in a respective pedestal conical seat; the assembly further includes a pair of screws each having a conical head sized to seat in a respective rail seat; and in assembled relation each conical head of each screw nests in a conical rail seat, each rail seat nests in a pedestal seat, and a threaded shank of each screw is threadably received in the cylindrical bore of the respective pedestal.

According to a further feature of the invention, each cylindrical bore is smooth and each screw is a self-tapping screw which self-tappingly engages the smooth cylindrical bore of the respective pedestal.

According to a further feature of the invention, the module is formed of a plastics material in a molding operation and the pedestals are formed integrally with the main body planar portion.

According to a further feature of the invention, the rail defines an inboard face proximate the module plate and an outboard face; the conical seats open in the outboard face of the rail; and the heads of the installed screws are flat and flush with or below the outboard face of the rail.

According to a further feature of the invention, each pedestal includes an outer annular wall and a concentric inner annular wall defining the bore.

According to a further feature of the invention, the inner and outer walls are joined at the free end of each pedestal and the conical seat is formed at the joint of the inner and outer walls.

According to a further feature of the invention, each outer wall is reinforced by a plurality of circumferentially spaced buttresses extending angularly between the planar main body portion of the module plate and the outer wall.

According to a further feature of the invention, the planar main body portion of the module plate includes an inboard face proximate the rail and an outboard face remote from the rail and the threaded shanks of the screws terminate short of the plane of the outboard face of the module plate.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a somewhat schematic exploded view of a motor vehicle door structure;

FIG. 2 is a side elevational view of a door module forming a part of the motor vehicle door structure.

FIG. 3 is a cross-sectional view taken on line 3-3 of FIG. 2;

FIG. 4 is a perspective view of a fragmentary portion of a module plate forming a part of the door module;

FIG. 5 is a fragmentary end elevational view of the door module; and

FIG. 6 is an exploded perspective view of the module plate and a rail for attachment to the module plate.

### DETAILED DESCRIPTION OF THE PREFERRED EMBODIMENT

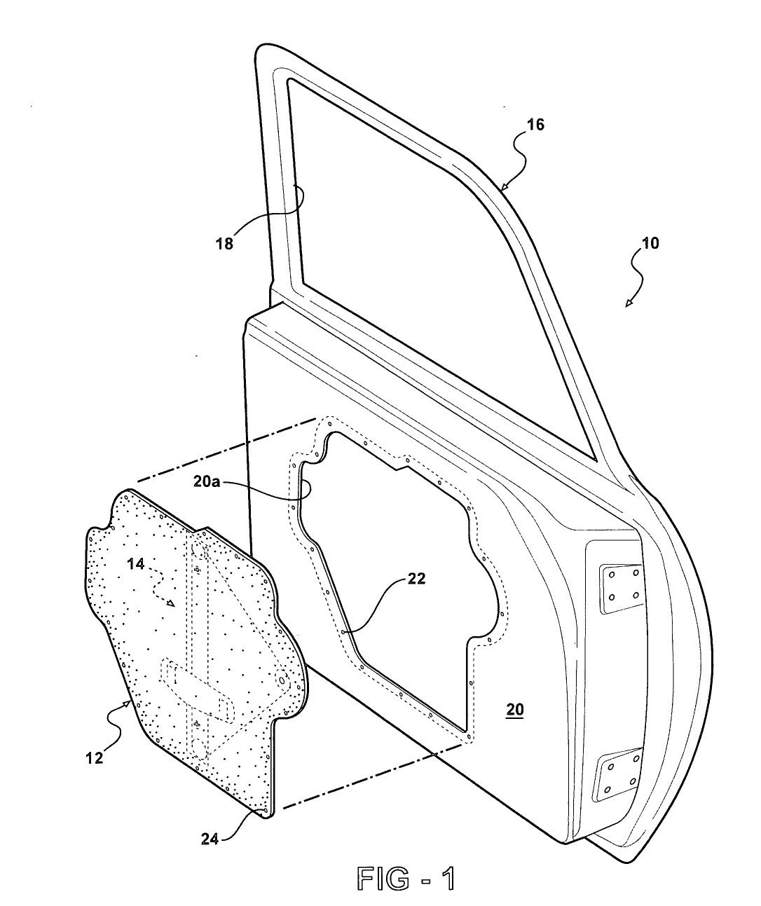

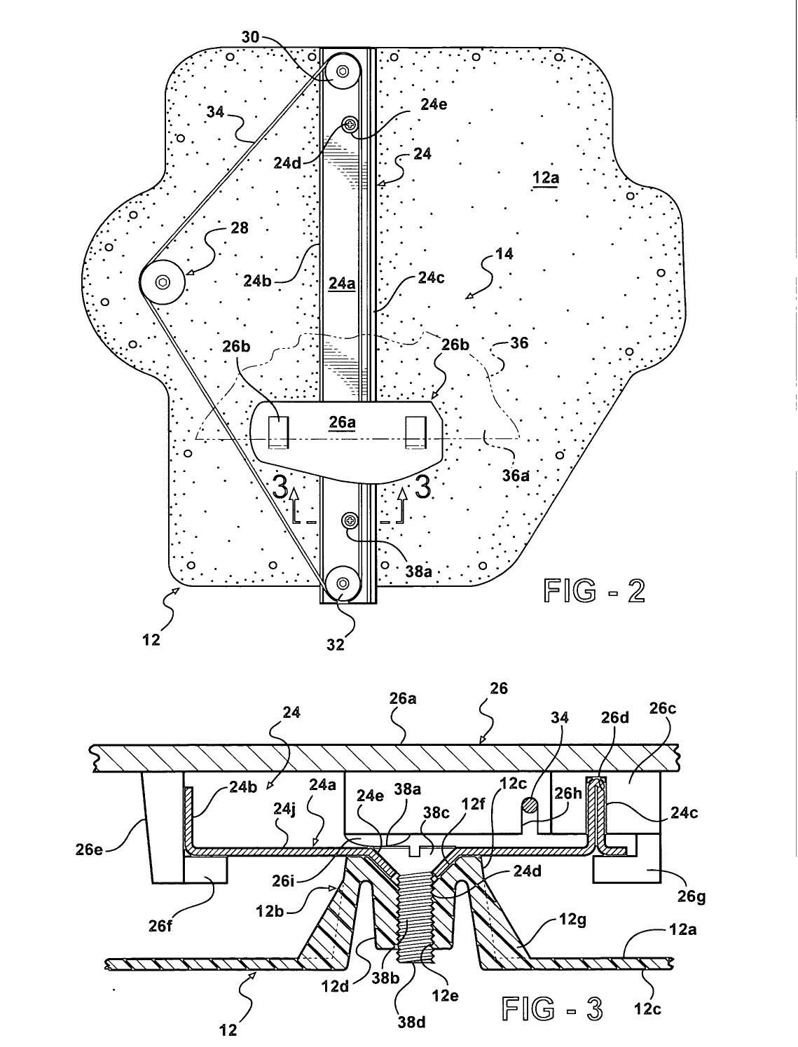

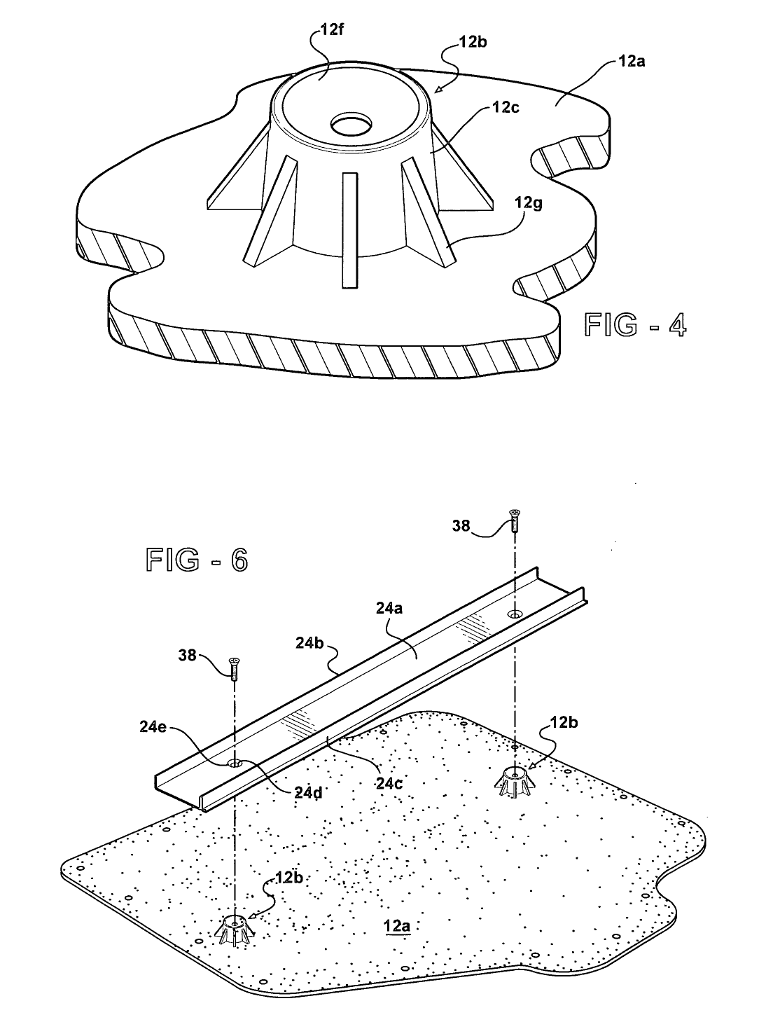

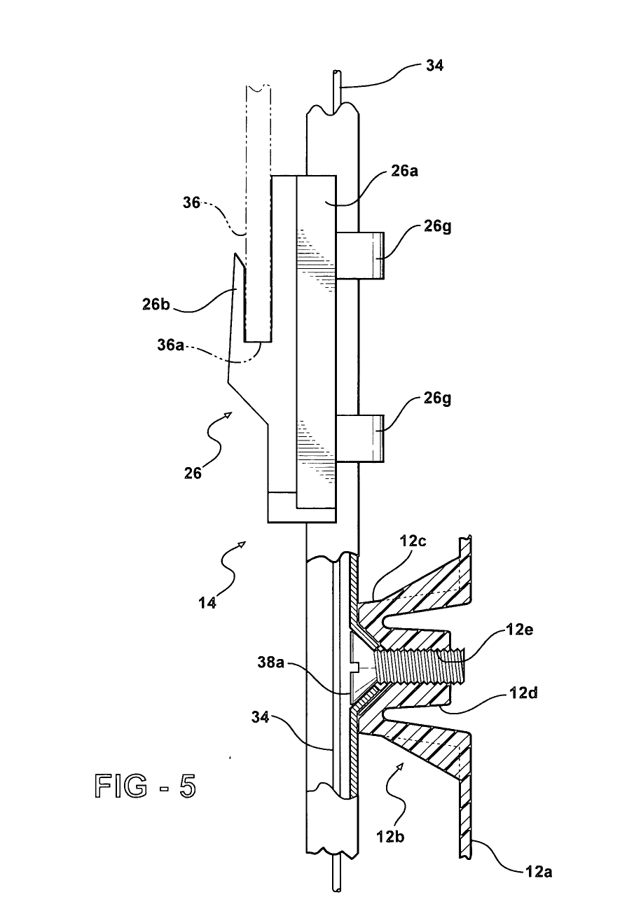

The motor vehicle door assembly seen in exploded form in FIG. 1 includes a door structure 10 and a door module 11 including a module plate 12 and a window regular assembly 14.

Door structure 12 includes a frame portion 16 defining a window opening 18 and an inner panel 20 defining a module opening 20a and a plurality of apertures 22 in spaced surrounding relation to the opening 20a. Door structure 10 is typically formed as a metal fabrication.

Module plate 12 is typically formed of a plastics material in a molding operation, has a size and shape generally conforming to the size and shape of the door inner panel opening 20a, and is secured to the door inner panel within the dash line seen in Figure 1 utilizing suitable fasteners passing through apertures 24 in the module plate and inner door panel apertures 22.

Module plate 12 includes a main body planar portion 12a and a pair of vertically spaced pedestals 12b molded integrally with and upstanding from the main body planar portion. Each pedestal includes an outer annular wall 12c and a concentric inner annular wall 12d defining a smooth walled central bore 12e. The inner and outer walls are joined at the free outer ends of each pedestal and a concave frusto conical seat 12f is formed at the joint of the inner and outer walls in concentric surrounding relation to the respective bore 2e. The outer wall 2c is reinforced by a plurality of circumferentially spaced buttresses 12g extending angularly between the main body planar portion 12a and the outer wall.

Window regular assembly 14 includes a guide rail 24 mounted vertically on the module plate, a glass carrier 26 slidably mounted on the rail, a drum 28 rotatably supported on the module plate for manual or power actuation, pulleys 30 and 32 mounted on upper and lower ends of rail 24, and a cable 34 fastened to carrier 18 and trained over pulleys 22, 24 and wound around drum 20. It will be understood that, in known fashion, manual or power rotation of the drum 20 has the effect of raising and lowering carrier 26 and thereby raising and lowering a window glass 36 carried by the carrier.

Guide rail 24 is formed as a stamped sheet metal member and preferably has a slightly bow shaped configuration from end to end. Rail 24 includes a main body planar central region 24a, a simple upturned flange 24b bordering one longitudinal edge and an upstanding double fold flange 24c bordering the other longitudinal edge. Rail 24 further includes a pair of vertically spaced apertures 24 with a concave, frusto conical seat 16e in surrounding relation to each aperture. Each conical seat is formed as sheet metal struck downwardly from the main body central region of the rail in a stamping operation which may be performed simultaneously with the piercing of the related aperture. Each conical seat 24e is sized and configured to nest snugly within a respective pedestal seat 12f.

Glass carrier 26 comprises a generally planar molded part and includes a main body portion 26a, laterally spaced fingers 26b sized to receive the lower edge 36a of window glass 36, a guide rib 26c defining a guide channel 26d slidably receiving guide rail double fold flange 24c, a guide finger 26e guiding on flange 24b and including an inturned portion 26f guiding under rail main body portion 24a proximate flange 24b, and a pair of guide fingers 26g guiding under rail main body portion 24a proximate flange 24c. Carrier 26 further includes a groove 26h for receipt of cable 34 and a rub knob 26i for guiding on the upper outboard face 24j of rail main body portion 24a.

To secure the rail 24 and glass carrier 26 to the modular plate, the rail seats 24e are positioned nestingly in the pedestal seats 12f and a self tapping screw 38, with a flat conical head 38a and a threaded shank 38b, is passed downwardly through each rail aperture 24d to engage the shank 38b with the smooth bore 12e. Turning of the screws will self-tappingly advance the screws in bores 12e and seat the conical heads of the screws in the conical seats 24e. In tightened mode the flat top 38c of each screw is positioned flush with or below the plane of the outboard face 24j of rail 24 and the tip 38d of each screw shank, by virtue of the fourshortened configuration of inner walls 12d relative to outer walls 12c, terminates short of the plane of the outboard face 12h of the module plate.

The invention will be seen to provide many important advantages. Specifically, the inter-nesting conical seats provide a self-locating feature with respect to the location of the rail on the module plate for ease of assembly; the invention provides a simplified attachment of the rail to the module plate which effectively resists movement of the rail relative to the module plate in response to external forces; the invention attachment arrangement provides a flush attachment which will not interfere with travel of the carrier along the rail; the invention reduces the number of fasteners typically required to secure the rail to the module plate and concomitantly reduces the labor required to attach the rail to the module plate; and the invention in general reduces the complexity and expense of the window regulator mechanism.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A door module positionable in the door structure of a motor vehicle door and including a module plate, a vertical rail for securement to the plate, and a glass carrier slidable vertically on the rail to raise and lower the glass, characterized in that:
the plate includes a pair of vertically spaced cylindrical pedestals each defining a bore;
a conical socket is defined at the free end of each pedestal in surrounding relation to the respective bore;
the rail includes a pair of vertically spaced apertures;
a conical depression is defined in surrounding relation to each aperture;
the conical depressions are seated in the conical sockets; and
the rail is fixedly secured to the plate by a pair of screws passing through the apertures and into the bores and having conical heads seated in the conical depressions.

2. A door module according to claim 1 wherein:
the bores are smooth walled; and
the screws are self tapping screws which self-tappingly engage the smooth walls of the respective bores.

3. A door module including a module plate, a vertical rail secured to the module plate, and a glass carrier mounted for vertical sliding movement on the rail, characterized in that:
the module plate includes a main body planar plate portion and a pair of vertically spaced annular pedestals upstanding from the main body planar plate portion;
each pedestal defines a cylindrical bore and an annular concave conical seat in surrounding relation to the bore at the free end of the pedestal;
the rail includes a pair of vertically spaced apertures with a concave conical seat in surrounding relation to each aperture sized to nest in a respective pedestal conical seat;
the assembly further includes a pair of screws each having a conical head sized to seat in a respective rail seat; and
in assembled relation each conical head of each screw nests in a conical rail seat, each rail seat nests in a pedestal seat, and a threaded shank of each screw is threadably received in the cylindrical bore of the respective pedestal.

4. A door module according to claim 3 wherein:
each cylindrical bore is smooth; and
each screw is a self tapping screw which self tappingly engages the smooth cylindrical bore of the respective pedestal.

5. A door module according to claim 3 wherein:
the module is formed of a plastics material in a molding operation; and
the pedestals are formed integrally with the main body planar portion.

6. A door module according to claim 3 wherein:
the rail defines an inboard face proximate the module plate and an outboard face;
the conical seats open in the outboard face of the rail; and
the heads of the screws are flat and flush with or below the outboard face of the rail.

7. A door module according to claim 3 wherein each pedestal includes an outer annular wall and a concentric inner annual wall defining the bore.

8. A door module according to claim 7 wherein the inner and outer walls are joined at the free end of each pedestal and the conical seat is formed at the joint of the inner and outer walls.

9. A door module according to claim 8 wherein each outer wall is reinforced by a plurality of circumferentially spaced buttresses extending angularly between the planar main body portion of the module plate and the outer wall.

10. A door module according to claim 3 wherein:
the planar main body portion of the modular plate includes an inboard face proximate the rail and an outboard face remote from the rail; and
the threaded shanks of the screws terminate short of the plane of the outboard face of the module plate.
